(19) United States
(12) Patent Application Publication
(10) Pub. No.: US 2004/0078734 A1
(43) Pub. Date: Apr. 22, 2004

(54) Method for displaying error messages in software applications

(76) Inventor: Andreas Deuter, Blomberg (DE)

Correspondence Address: CHARLES E. BAXLEY, ESQUIRE, Fifth Floor, 59 John Street, New York, NY, 10038, US

(21) Appl. No.: 10/375,278

(22) Filed: Feb. 26, 2003

(30) Foreign Application Priority Data
Mar. 7, 2002 (DE) 102 10 145.0

(51) Int. Cl. G06F 11/00

(52) U.S. Cl. 714/57

(57) ABSTRACT

The invention provides a method in a software application for displaying status and error messages in software applications in such manner that the running of programs in the active application is not interrupted, for which a status line is generated, wherein when an error occurs while a software application is running, an error message regarding is displayed in the status line on a graphical user interface and wherein the software application continues to run.

The invention relates to a method for displaying error messages in software applications, particularly a method for displaying error messages that avoids interrupting the execution of the program.

In modern software applications, the most frequently employed method of informing users about the status of a program and errors therein is message boxes.

However, these known message boxes interrupt the running of the application in a manner that is irritating to the user. This occurs particularly when the application ceases to run until the user clicks on the message box with a status or error message to close it. If the user does not constantly monitor a computer program running on the monitor, independent program execution may be halted by the appearance of such a message box.

Equally, if an error has occurred or if a status message has been displayed that is particularly important to the user, or which is significant for the data being output by the program, the output of error messages using message boxes in the known manner results in the loss of the information with the acknowledgment click. The user is thus no longer able to refer to the information provided in the message box, for example when the program has finished running and/or after the processed data has been output.

On the other hand, if an error made by the user is already known to the user, such as incorrect input in a dialog window, the user is disturbed unnecessarily by the display of such a message box.

Moreover, in applications that are integrated in other applications, message boxes of such kind are quite unsuitable. Computer programs of this kind include for instance ActiveX applications, in which ActiveX Controls are incorporated into an ActiveX Container. Here, such message boxes are unsuitable because it is often the case several integratable applications of the same type are running inside one container. The user therefore cannot determine the application to which the content of such a message box refers.

Status lines are also known, in which status messages are output. Such status lines are frequently located in the bottom portion of a window of a graphical user interface. However, a status message in such a status line has the disadvantage that the detail of the message is limited by the pre-determined length of the status line. Such a status line according to the prior art has the further disadvantage that previous status messages cannot be recalled.

In addition, help systems or help programs are known from known software applications that help the user to operate the program correctly. Such help systems are frequently called by pressing a key or key combination, such as the F1 function key, via a menu item or by activating a button on the graphical user interface with the mouse pointer. The help system often provides context sensitive help also. However, these help systems provide no information on the content of message boxes. This means that the user is often unable to determine the reason for the occurrence of an error while the program is running. As a result, it is more difficult or even impossible to avoid making the same error again.

The task of the present invention is therefore to eliminate the disadvantages outlined in the aforegoing in running software applications. This task is solved by with the method according to the invention in a manner that allows the use of message boxes to be dispensed with completely.

This task is solved in a surprisingly simple manner by a method for displaying status and error messages in software applications in accordance with claim 1.

Accordingly, a method is provided for displaying error messages in software applications for which a status line is generated, wherein an error message is displayed in the status line of a graphical user interface for an error occurring while the software application is running, and the software application continues to run.

In this way, the method according to the invention allows error messages to be represented in a clear manner in the status line of the user interface, so that the user is informed of problems that have occurred. On the other hand the software application continues to run without a message box requiring an acknowledgment click. This method of error message handling is particularly advantageous with applications that run automatically without user interaction.

The method for displaying error messages according to the invention is particularly beneficial as an implementation in software applications for controlling and/or monitoring automatic manufacturing processes, especially in industrial applications. Such software applications are normally intended to run continuously in batch mode without further user interaction after initialization or parameter inputs. In this context, a message box display accompanied by a program interrupt may have fatal consequences if the production process stops as a result. For example, the method may be executed in a stored program controller (SPC) that is equipped with a corresponding user interface or a graphical user interface.

In this regard, advantageous applications of the invention include stored program control for a fieldbus and/or the components connected thereto. A diagnostics device for such a control unit with the corresponding software application may also benefit from using the method according to the invention. A latency or interrupt in the SPC computer program by reason of a message box that conveys a message relating to an error that is not critical for the process run may lead to costly system failures. In the same way, halting the diagnostic functions of the diagnostics device would interrupt the monitoring of the process run, so that the method according to the invention, which avoids such an interruption, is of particular benefit in these cases.

The method may be integrated neatly into the application in the form of a function. In order to output the error message, the function may transfer it to at least one other function of the software application. For example, this at least one other function may control the output of messages in the status line of the graphical user interface.

When an error occurs, an error message is preferably generated in such manner that the previous status message displayed in the status line is not overwritten with this error message.

The method according to the invention may be implemented particularly advantageously in applications that run on a 32-bit Microsoft® operating system, such as Windows 95®, Windows 98®, Windows 2000® or Windows NT®, in which the use of message boxes to display error messages is otherwise standard.

One advantage of the present invention is that the execution of the program is not interrupted by the appearance of message boxes, which must first be deactivated in order for the program to continue. In order to permit the display of further status and error messages, the method may be advantageously configured so that the error message is displayed in the status line until such time as another status or error message is generated.

In order not to interrupt the flow of information to the user, and to enable the further display of information that may be important to the user, the error message in the status line may be replaced to good purpose by the text of a subsequent status or error message. In this way, the status line may be reused to display the status of the computer program, and the status messages are not blocked by the error messages.

In particularly advantageous manner, the method according to the invention for displaying status and error messages may also be customized to the needs of experienced and inexperienced users of the respective software applications. An experienced user may be able to analyze, and if necessary remedy, the error even on the basis of the limited text in the status line or the text box. By calling a help system, a novice user may also be provided with the means to learn in detail the possible causes and remedies for an error. For this purpose, one embodiment of the method provides that information on the error message may be made available by calling the software application's help and/or information program.

The text box in which the status and error messages are displayed may also usefully be assigned to one or more buttons, with which the software application's help and/or information program can be called. In this way, the invention provides for combined use of status line and help system in a software application. During normal running of the program, the status of the program or the status of processes that are currently being run is displayed in one or more windows of the graphical user interface.

The method may also be configured so that the error message is overwritten in the status line by the current status message after a predetermined time interval.

The number of characters in the error text may advantageously be limited in order to take advantage of the restricted length of the status line.

Moreover, the error text may be truncated automatically, perhaps via a suitable software routine, if the wording exceeds the length of the status line.

The normal program status is displayed again after the limited time for the error display has elapsed. The error message continues to be displayed as a text box. The text box is preferably assigned to a switch or a button which is placed on the user interface. Pressing the button may, for example, launch the application's help and/or information program to provide context-sensitive help on the error that has occurred. It may also be possible to provide several buttons for calling help functions, perhaps one button for calling context-sensitive information on status messages and another for launching a help-system which provides support for error messages and/or troubleshooting the errors that have occurred.

In order to ensure that error information remains available to other users, the error message may also be shown in another field. In this case, it is especially advantageous if this field is retained in the status line after the error message has been overwritten and the information thus remains available to the user. To this end, the window may be a separate text box. The error text may also be made available as Tooltip text, for example for an information button. For example, the information and/or help systems may also be assigned to the information button, and the context-sensitive help and/or information on the error message is displayed as text in the status line and/or as Tooltip text.

This method enables a software application to continue running despite the occurrence of errors without the need for user intervention. The user therefore does not need to monitor the software application constantly. In order to be able to review the errors that occurred, however, a practical measure is to ensure that the error messages may be stored in a file, such as an error log file.

The method according to the invention may also be integrated in a software component that is bundled in a superior software application. In this case, data is preferably exchanged and the error message is also transmitted via a software interface. A suitable example of such is implementation in one or more ActiveX components, which are bundled in a superior application (and communicate therewith via the standardized ActiveX software interface.

The invention will be described in the following in terms of an exemplary embodiment and with reference to the attached drawing. In the drawing:

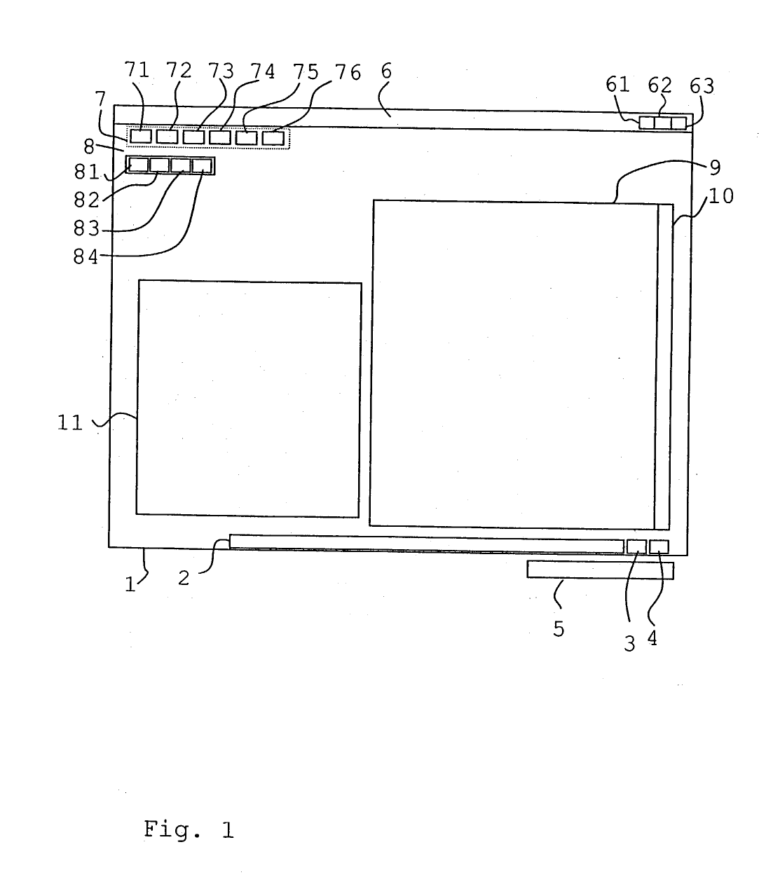

FIG. 1 is a schematic view of a window of a graphical user interface having elements for the realization of the method according to the invention for displaying status and error messages in software applications.

FIG. 1 shows a window of a graphical user interface displaying typical operation elements for running an application programs, and additional display and operation elements for the functions of the present invention. The user interface shown in FIG. 1 may for instance be the user interface for a software application that runs on a platform with a Microsoft® operating system. In general, a window 1 has buttons 61, 62, 63, which are used to minimize, maximize and close window 1. In standard user interfaces, these buttons are usually on the right side of title bar 6, in which the title of the program or the sub-program assigned to window 1 is displayed. A menu bar 7 with menu items 71, 72, . . . , 76 is normally located below title bar 6. The menus are often subdivided further into submenus, which are activated by clicking on the respective main menu item. Under one of the menu items 71, 72, . . . , 76, the application program's help system may be called.

Toolbars are frequently located below menu bar 7, and these are represented in FIG. 1 by a single toolbar 8. Toolbar 8 normally includes several buttons 81-84, furnished with symbols, the symbols or icons representing the functions that may be called by activating the respective buttons 81-84. The processed and/or entered data are frequently represented by input/output windows 9, which may also include scroll bars 10. One or more dialog windows 11 may also be located on the window to enable settings to be made affecting the running of the program.

A status line 2 normally appears on the bottom border of window 1, which status line displays current status messages, such as a message to the effect that a file has been read completely from the hard disk or has been stored on the hard disk.

In the event of an error while applications are running, for instance if the file to be read is corrupt, according to the prior art a message box will appear with information for the user about the error. This message box includes a button so that the message box vanishes when the button is activated and the application is then able to continue running. The exemplary interface in FIG. 1 may thus be, for example, a user interface for a software application to control and/or monitor industrial manufacturing processes.

In the method according to the invention, however, the error message is not shown in such a message box, it preferably appears in the status line 2 of the software application.

According to this embodiment of the invention, the error message shown in status line 2 is truncated if it is longer than the character limit for the status line. After a predetermined time interval, or if a new status message is available for display in the status line, the error message in the status line is overwritten with the current status message. Instead, the error message remains displayed in a text box 5. The error message may also be stored in a file to enable the user or users to check the errors that occurred at a later time.

Text field 5 is preferably assigned to one or more buttons 3, 4, which are located beside status line 2. For example, text box 5 may be a Tooltip text box that is assigned to of the buttons 3 or 4. Using buttons 3, 4, the application's help and/or information program can be called, wherein the help or information refers directly to the messages currently displayed in status line 2 and/or text box 5. The use of two buttons is preferred, wherein button 3, which is closest to status line 2, calls information relating to the error message, and the other button 4 activates a help function, which provides help in troubleshooting an error message displayed in status line 2 or text box 5.

As was indicated in the aforegoing, unlike the error handling method known in the state of the art, the programs in applications into which the method according to the invention has been integrated are not interrupted. For example, if a corrupt file has been loaded that cannot be processed by the computer program, an error message would simply appear in status line 2. Thus the user would be able to load another file immediately, for example, without first having to acknowledge the message box, and an experienced user would already know the reason why the previous file could not be loaded. At the same time, an inexperienced user would be able to click on one of the buttons 3, 4 assigned to text box 5 and/or to status line 2, and thus call the help and information system which provides more detailed information the error that occurred and, if possible, returns instructions for remedying the error.

By displaying the error message in status line 2 of the graphical user interface of the software application, particularly in applications that are integrated in other applications, the method according to the invention further provides the user the advantage of knowing exactly which of the integrated applications has caused the error message to be displayed in every case. In contrast, the output of error messages in message boxes according to the state of the art does not enable the user to discern which of the integrated applications has triggered the error message in the message box. For example, the method may be integrated in one or more software components that are bundled in a superior software application.

The graphical user interface may also be generated and controlled by an integrated software component. ActiveX components are especially suitable for this purpose. They communicate with the higher order application or other components via standardized software interfaces. Thus for example an error message may be generated by any component and correspondingly transferred via the software interface to another component, which is tasked with the output of status and error messages. The error message may thus also include information on the component that transferred the error message.

1. A method for displaying error messages in software applications, for which a status line is generated,
characterized in that
in the event of an error that occurs while a software application is running, an error message is shown in the status line on a graphical user interface, and the software application continues to run.

2. The method according to claim 1, characterized in that the method is implemented in a software application for controlling and/or monitoring an automatic manufacturing process.

3. The method according to claim 2, which is executable in a stored program controller.

4. The method according to claim 3, wherein the stored program controller controls a fieldbus and/or components connected thereto.

5. The method according to any of claims 1 to 4, which is implemented in a diagnostic device for a stored program controller.

6. The method according to any of claims 1 to 5, characterized in that the software application runs on a 32-bit Microsoft® operating system, particularly Windows 95®, Windows 98®, Windows 2000® or Windows NT®.

7. The method according to any of claims 1 to 6, characterized in that the error message is replaced in the status line by a subsequent status or error message.

8. The method according to any of claims 1 to 7, characterized in that a help and/or information program can be called, which makes information on the error message available.

9. The method according to claim 8, characterized in that the help and/or information program of the software application can be called by means of buttons assigned to the status line.

10. The method according to any of claims 1 to 9, characterized in that the error message is displayed in at least one other field (5).

11. The method according to claim 9 or 10, wherein the error message is displayed as Tooltip text (5).

12. The method according to any of claims 1 to 11, wherein the error message is stored in a file.

13. The method according to any of claims 1 to 12, wherein the method is integrated in at least one software component and wherein the software application is superior to the software component.

14. The method according to claim 13, wherein the software component is connected to the superior software application and/or to other software components via a software interface.

15. The method according to claims 13 or 14, wherein the software component includes an ActiveX component.
